(19) United States
(12) Patent Application Publication
(10) Pub. No.: US 2026/0010918 A1
(43) Pub. Date: Jan. 8, 2026

(54) SYSTEMS AND METHODS FOR WIRELESS COMMUNICATION INTEGRATION WITH GARMENT

(71) Applicant: ProductionPal, LLC, Monticello, MN (US)

(72) Inventors: Jaime Merlin Boxell, Monticello, MN (US); James Bryan Boggs, Burlington, NC (US); Keir Finlow-Bates, Eura (FI)

(21) Appl. No.: 19/262,715

(22) Filed: Jul. 8, 2025

Related U.S. Application Data
(60) Provisional application No. 63/668,396, filed on Jul. 8, 2024.

(51) Int. Cl. G06Q 30/018; G06K 19/07

(52) U.S. Cl. CPC G06Q 30/0185; G06K 19/0723

(57) ABSTRACT

Systems and methods for digital content access based on a wirelessly-integrated garment are described and contemplated herein. A wirelessly-integrated garment includes a Near Field Communication (NFC) or High Frequency Radio Frequency Identification (HF RFID) tag. A user possessing the wirelessly-integrated garment can use a computing device to energize and communicate with the NFC/HF RFID tag to transfer associated digital content associated with the tag.

### CROSS REFERENCE TO RELATED APPLICATION

This present application claims the benefit of U.S. Provisional Application No. 63/668,396, filed Jul. 8, 2024, which is hereby incorporated herein in its entirety by reference.

### TECHNICAL FIELD

Embodiments relate generally to clothing, and more specifically to garments with integrated wireless communication technology.

### BACKGROUND

The digitalization of the music industry has introduced a series of challenges, including digital piracy, streaming dominance, copyright infringement, market saturation, and data privacy/security concerns. The rise of the internet has made it easier for people to illegally download music, leading to significant revenue losses for artists and labels. Further, while streaming services have revolutionized music consumption, streaming services also present challenges in terms of fair compensation for artists and the devaluation of music as a commodity.

Due to the decrease of sales of physical products as well as music piracy, there is a need to better protect ownership and fair compensation of copyrighted music.

### SUMMARY

Embodiments described or otherwise contemplated herein substantially meet the aforementioned needs of the industry. Embodiments described herein include systems and methods for integrating wireless communication technology into generally wearable garments. Garments suitable for use with the present disclosure include, but are not limited to, shirts, t-shirts, sweatshirts, hoodies, jackets, hats, shoes, pants, gloves, ties, bandannas, lapel pins, and/or decorative pins. In other aspects, wireless communication technology as described and considered herein can include concert ticket integration embodied in paper products such as thermal paper or other physical materials. Though “garment” is generally used throughout, it is understood that contactless tags can likewise be integrated in other items like tickets and other physical items.

In an embodiment, a system for integrating wireless communication technology into generally wearable garments comprises: a garment comprising a contactless technology tag, wherein the contactless technology tag is associated with a digital asset and a device comprising a memory and at least one processor. The device can be configured to: send a signal configured to energize the contactless technology tag; receive, from the contactless technology tag based on the signal, a unique identifier associated with the garment and instructions for accessing the digital asset; authenticate, via a cloud service, the garment based on the unique identifier and the instructions; receive, from the cloud service, an indication that the garment is authenticated; and receive, based on the indication that the garment is authenticated, the digital asset.

In an embodiment, a method for integrating wireless communication technology into generally wearable garments comprises: sending a signal configured to energize a contactless technology tag integrated into a garment, wherein the contactless technology tag is associated with a digital asset; receiving, from the contactless technology tag based on the signal, a unique identifier associated with the garment and instructions for accessing the digital asset; authenticating, via a cloud service, the garment based on the unique identifier and the instructions; and receiving, based on a determination that the garment is authenticated, the digital asset.

In a feature and advantage of embodiments, recording artists, performing artists, and audio industry professionals are provided a wide variety of physical products to integrate with RFID technology, including garments, items, or objects used to promote the sale of music or sound recordings in general. Systems and methods for packaging wireless devices in garments for the conveyance of music, audiobooks, film, software, and artificial intelligence (AI) models are provided herein. For example, in the context of software and AI, a band can provide code that emulates instrument sounds, allowing fans to reproduce its signature tone, or AI models that allow fans to chat with an AI avatar of the band members.

In another feature and advantage of embodiments, live concert audio/video can be assigned to merchandise, so fans who attend and make a purchase will later own the exact audio/video of the concert they attended.

In another feature and advantage of embodiments, “blank” garments are provided, like “blank” such that the digital assets one already owns rights for can be “recorded” on the “blank” garments in order to create personalized playlists, etc. A shirt can be “blank” until a link is authorized and assigned to the shirt, then the tag is populated with the relevant information to recall the digital asset.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for digital content access based on a wirelessly-integrated garment, according to an embodiment.

FIG. 2 is a combined block diagram and flowchart of a system for digital content access based on a wirelessly-integrated garment, according to an embodiment.

FIG. 3 is a block diagram of a blockchain for digital content access based on a wirelessly-integrated garment, according to an embodiment.

FIG. 4 is a combined block diagram and flowchart of a system for digital content access based on a wirelessly-integrated item, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

In an embodiment, a garment is operably coupled (e.g. internally or externally affixed) with a Near Field Communication (NFC) or High Frequency Radio Frequency Identification (HF RFID) tag. An end user possessing the garment (e.g., regardless of whether they are wearing the garment) can use a computing device to energize the NFC/HF RFID tag and communicate with the NFC/HF RFID tag to transfer associated digital content. In an embodiment, the NFC/HF RFID tag is itself energized (such as by an integrated battery). In such aspects, the end user possessing the garment interacts with the NFC/HF RFID tag to initiate communication with the NFC/HF RFID tag instead of energizing the NFC/HF RFID tag.

The computing device can be any device configured with processing capabilities, such as an RFID reader or a mobile device (e.g., a NFC-capable smartphone, tablet, laptop, etc.). Data transferred from the tag is used to authenticate digital rights and thereby grant access to associated digital content, such as digital audio content. In an embodiment, a website, platform, or application can be used for authentication. For example, the tag can be authenticated by comparison of a pair of barcodes, passcodes, or passwords. For example, the tag can be authenticated using a hashing function. Upon successfully authenticating digital rights to the associated digital content, the associated digital content may be accessed (e.g. streamed), for example, from website(s). In an embodiment, blockchain technology is used to create an auditable trail.

In an example, embodiments include a garment integrated with an NFC or HF RFID tag (sometimes referred to herein as simply a tag). The garment with an integrated tag is used to package the transfer (e.g., sale) of digital content (e.g., digital audio content), such as music, audiobooks, and sound recordings by utilizing NFC or HF RFID tag technology. For example, an NFC capable device such as a smartphone can operatively parse the NFC or HF RFID tag data stored in memory. This is achieved through allowing the device's NFC circuitry to send an oscillating signal from its internal NFC coil. Electricity flows through the circuitry of the chip, generating a magnetic field. This magnetic field generated by an NFC capable device induces a magnetic field in the NFC or HF RFID tag coil, establishing a state of inductive coupling between NFC device and NFC or HF RFID tag integrated with the aforementioned garment. The magnetic field induces electricity in the NFC tag, which creates a radio field. The radio field generated by the tag interacts with the field generated by the NFC device hardware and mobile application software that operatively detects and decodes the radio field. The tag information transferred may be used to authenticate digital rights and thereby grant access to specific digital audio content available through a specific website, or plurality of websites, by matching a pair of barcodes, passcodes, or passwords; further, upon successfully establishing digital rights to specific digital audio content, said content may be accessed from the website(s).

In an embodiment, the RFID tag can be a passive RFID tag. For example, a passive RFID tag can be a battery-less tag without an internal power source. Rather, the tag can be instead powered by the energy transmitted from an RFID scanner. In an embodiment, the RFID tag can be an active RFID tag, having a long-lasting battery and configured to continuously send signals and transmit data stored on the tag. In an embodiment, the RFID tag can be a semi-passive RFID tag having an internal battery as well as an antenna and microchip or integrated circuit, with a generally lower signal range when compared to an active RFID tag. In embodiments, RFID tags can operate across various frequencies, including 30-300 Khz. In another example, RFID tags can operate across 125-134 KHz, also known as Low Frequency (LF), 13.56 MHz, also known as High Frequency (HF), and Near-Field Communication (NFC), and 865-960 MHz, also known as Ultra High Frequency (UHF). In embodiments, the frequency of the signal can be one of 13.56 MHz, 125 KHz to 135 KHz, or 860 MHz to 960 MHz.

In an embodiment, garments can include concert shirts, t-shirts, sweatshirts, hoodies, jackets, hats, shoes, lapel pins, decorative pins, or any other suitable garment, decorative keychains, key fobs, clothing patches, stickers, labels, sunglasses, placards, posters, index cards, rings, pendant necklaces, bracelets, charms.

In an embodiment, digital rights and access to digital content can be authorized by communication with a website, micro-site, virtual private network (VPN), or server that uses blockchain technologies.

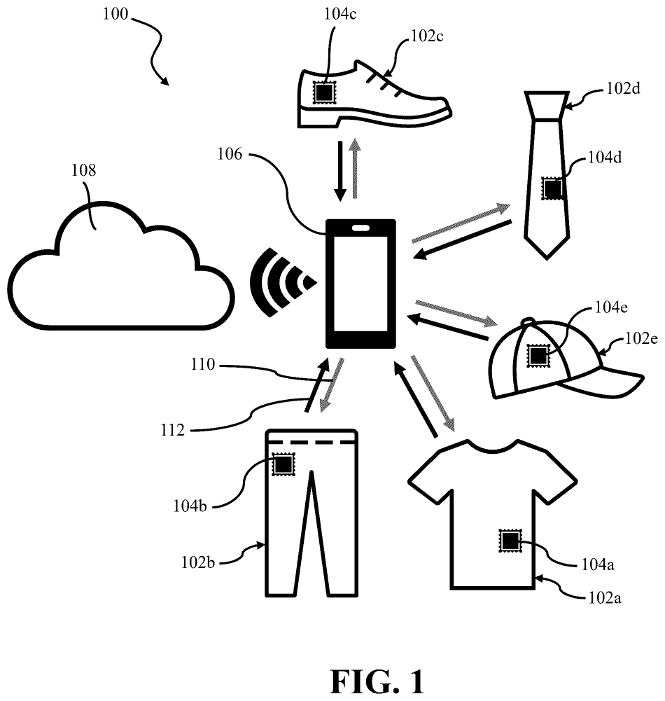

Referring to FIG. 1, a system for digital content access based on a wirelessly-integrated garment, according to an embodiment. System 100 generally comprises one or more garments 102 integrated with a wireless communication component 104, such as an RFID tag, a computing device 106, and a network 108.

Garments 102 can comprise one or more of a t-shirt 102a with an integrated RFID tag 104a, a pair of pants 102b with an integrated RFID tag 104b, a shoe 102c with an integrated RFID tag 104c, a tie 102d with an integrated RFID tag 104d, and a hat 104e with an integrated RFID tag 102e. In other embodiments, garments 102 can further include other wearable or affixable items having an integrated communication component.

Wireless communication component 104 can be integrated into a contactless technology tag, such as an RFID tag or near field communication NFC tag. A contactless technology tag comprises a wireless communication component 104 integrated into respective garment 102. In an embodiment, RFID tag 104 is configured for near-field communication with a proximately-located device (e.g. computing device 106). In an embodiment, RFID tag can include an integrated circuit (IC) having memory, and an antenna.

The fastening, attachment, or other coupling of the RFID tag can vary depending on garment style. T-shirts, sweaters (e.g., hoodies), and jackets can benefit from having the tag sewn into hemlines, pocket stitching/lining, cuffs, or collar. Attachment locations can include in the front of the garment, near the chest or waistline where NFC signals are more easily achieved. In an embodiment, a tag can be ironed directly into the garment, or in addition, behind a patch or logo. (e.g. for hats, shoes, vests, and jackets with one or multiple patches/logos). In an embodiment, the tag can comprise a wire form or a disc form. In an embodiment, the tag can be sewn into collars, hemline seams, pocket stitching, hat brims/rims, etc. In an embodiment, the tag can comprise an embeddable wire having a 360° read profile to reduce orientation sensitivity and can be embedded into materials like the rubber soles of shoes, bracelets, necklaces, and rings.

In an embodiment, multiple tags can be implemented on one garment. For example, a jacket or vest can have multiple patches and corresponding RFID tags to allow access to different content. For example, a KISS jacket could include a tag with every KISS album or a tag for a (e.g., each) KISS album. Each RFID tag associated with a patch can populate on the list of available links (or access instructions). In other embodiments, multiple tags can be used in coordination to ensure that a primary tag remains associated with a garment using a secondary tag, as will be discussed further.

Computing device 106 comprises an electronic device in communication with system 100. For example, computing device 106 comprises a device configured to communicate with RFID tag 104 and network 108. In an embodiment, computing device 106 can be an RFID reader, NFC-capable smartphone, mobile device, laptop computer, or tablet computer. Accordingly, device 106 can include at least an NFC reader sub-component. Further, computing device 106 can be configured to communicate with other networked devices, such as devices on network 108 via a wired or wireless communication channel implemented according to any suitable protocol, such as USB, BLUETOOTH, Internet Protocol (IP), Wi-Fi, Wi-Fi Mesh, UWB (Ultra-Wide Band), 5G, Li-Fi or other Visible Light Communications (VLC), LoRa, or any other appropriate format. Accordingly, device 106 further includes at least a transceiver configured for network communication.

Network 108 comprises a set of networked devices comprising network-based services, such as blockchain integration, authentication services, audio-visual digital content services, streaming services, interface services, and the like.

In an embodiment, network 108 can be used to access a service and/or database. For example, network 108 can be used by computing device 106 to access a distributed sequential transactional database, which may be referred to as a blockchain. A blockchain is a distributed chain of block data structures accessed by a network of nodes, referred to here as a miner network. Each block in the blockchain includes a plurality of record data structures known as transactions, each transaction referring or relating to a prior transaction. For example, in an embodiment a (e.g., each) blockchain includes a Merkle of hash or digest values for transactions included in the block to arrive at a hash value for the block, which is itself combined with a hash value for a preceding block to generate a chain of blocks (blockchain). Embodiments described above are also referred to as a proof-of-work blockchain.

A new block of transactions is added to the blockchain by miner software, hardware, firmware or combination systems in a miner network. The miners are communicatively connected to sources of transactions and access or copy the blockchain. A miner undertakes validation of the substantive content of a transaction and adds a block of new transactions to the blockchain when a challenge is satisfied as a proof of work, typically such challenge involving a combination hash or digest for a prospective new block and a preceding block in the blockchain and some challenge criterion. A (e.g., each) miner in the miner network can generate prospective new blocks for addition to the blockchain.

Where a miner satisfies or solves the challenge and validates the transactions in a prospective new block such new block is added to the blockchain. Accordingly, the blockchain provides a distributed mechanism for reliably verifying a data entity. The detailed operation of such blockchains and the function of miners in a miner network is beyond the scope of this specification. The manner in which the blockchain and network of miners operate promotes the adoption of verifiably valid transactions as new blocks added to a blockchain in a manner that is persistent within the blockchain. Transactions added erroneously or maliciously are not verifiable by other miners in the network and their persistence in the blockchain is undermined.

In other embodiments, a proof-of-stake blockchain can be utilized. In some embodiments, transactions may be added to candidate blocks for the blockchain, and blocks may be approved for inclusion on the blockchain by validators, said validators obtaining the right to append transactions and blocks by locking up value on the blockchain in a process of staking.

As further depicted in FIG. 1, in operation, device 106 is positioned proximate one or more of garments 102, such as t-shirt 102a. As illustrated by arrows 110 from device 106 to garments 102, device 106 provides energy to the circuitry of tag 104. In the example of t-shirt 102a, the NFC reader component of device 106 can power tag 104a via energy transmitted from device 106 to the antenna of tag 104a. Subsequently, as illustrated by arrows 112 from garments 102 to device 106, tag 104 can communicate information stored in memory to device 106 (e.g. tag 104a to device 106). In an embodiment, data including or otherwise facilitating a URL and authentication code to establish rights and access to digital content is communicated to device 106. In an embodiment, device 106 can then communicate with network 108 to authenticate garment 102a. Upon authentication (as will be described further herein), the user of device 106 is provided access to the digital content, such as by streaming, download, interface presentation, or other communication. For example, authentication and access to associated digital content can be implemented by a blockchain.

In an embodiment, energy harvesting can be implemented using tag 104 and device 106. Tag 104 can comprise a passive RFID tag on garment 102 that can reflect waves from device 106 (e.g., reader). Energy harvesting is a technique in which energy from the mobile device signal (e.g., of 13.56 MHz) is gathered by tag 104, stored briefly using capacitance, and used to transmit information back to device 106 (e.g., reader).

In an embodiment, tag 104 comprises a dual-band RFID passive tag antenna design in a compact size to operate for identification, tracking, and traceability in a supply chain. The HF RFID is employed for customer checks by using their own smartphone and energy harvesting in the tag. In an embodiment, the UHF RFID is used for the shipping process management with the same RFID tag. The energy harvesting can be achieved at the HF band by the coupling magnetic field received by the HF antenna to the chip at the output voltage pin. The antenna structure can comprise a rectangular spiral coil for the HF band and a dipole with meander lines and patches for the UHF band. The antenna structure can be shorted at the end of the dipole for size reduction, according to embodiments.

In an embodiment, tag 104 comprises an RFID tag with memory banks (e.g., four memory banks). In such an embodiment at least one memory bank can be reprogrammed. Memory banks within an RFID tag can include an electronic product code (EPC) memory bank and a user memory bank. Data can be programmed to the tag in, for example, two basic numbering systems-hexadecimal (hex) and/or ASCII. Hex code is the simplest and most popular way to program RFID tags, but ASCII will allow for special characters as well as numbers and letters.

In an embodiment, a unique identifier is stored in a first memory area (e.g., memory bank) of the tag. The unique identifier can be used as a preliminary protection mechanism for access to a second memory area (e.g., memory bank) of the tag which contains a key (e.g., cryptographic key, authentication token). The key can be used as an access key to a service, such as a blockchain. In embodiments, the service can authenticate the RFID tag and authorize access to digital content.

Hierarchical security access using separate memory banks in RFID systems involves organizing access permissions and data storage into multiple levels of security. Different access control levels can be assigned to each memory bank based on the sensitivity of the data stored within. For example, the EPC bank may have public read access for identification purposes, while the user memory bank may require authentication for read and write operations. Access policies can be implemented to govern which RFID readers or devices are allowed to access each memory bank. For example, access policies can be based on factors such as reader identity, user credentials, or environmental context (e.g., as can be indicated by sensors integrated and/or associated with the RFID tag).

In an embodiment, logging and auditing mechanisms are implemented to track access to each memory bank, allowing for accountability and traceability in case of security breaches or unauthorized access attempts.

By implementing hierarchical security access using separate memory banks, RFID systems can enforce fine-grained access control and protect sensitive data from unauthorized access or manipulation. This is particularly important in applications where privacy, security, and data integrity are paramount, such as asset tracking of garments 102.

In an embodiment, tag 104 comprises a wireless sensor network (WSN) or Bluetooth low energy (BLE) technology. In one aspect, RFID tags with WSN and/or BLE technology can incorporate sensors to collect additional data, such as temperature, humidity, or motion. The RFID tags can wirelessly transmit identification information and sensor data to RFID readers or other networked devices, enabling applications to monitor and adapt to conditions. In an example, tag 104 can be integrated with a sensor to transmit motion information such that the tempo of accessed digital audio can be selected (e.g., correlated, adjusted) based on determined motion of tag 104.

In an embodiment, tag 104 can be protected from unauthorized access or tampering by physical security measures, such as tamper-evident packaging, secure enclosures, and/or anti-counterfeiting features.

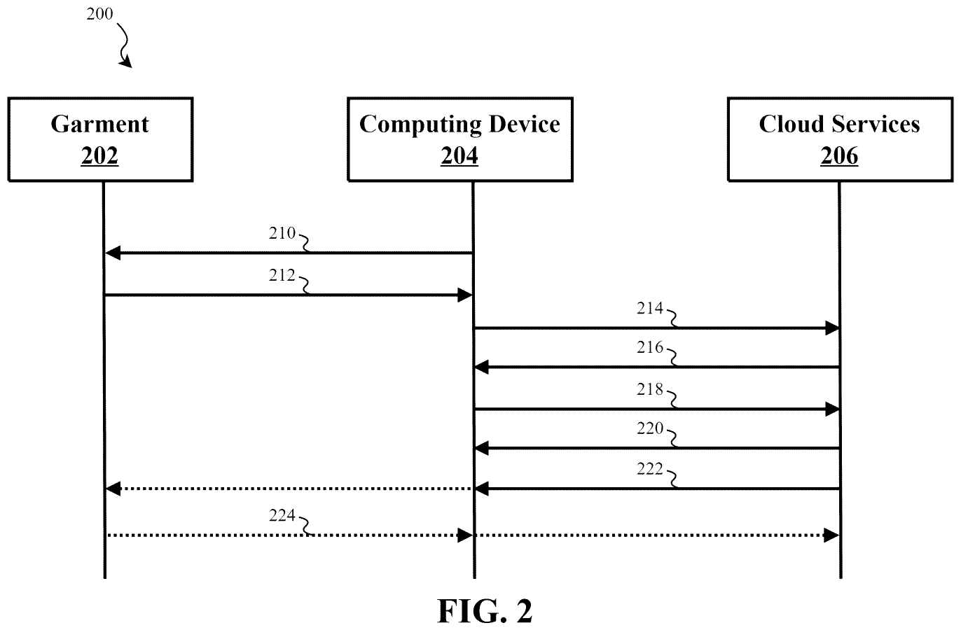

Referring to FIG. 2, a flowchart of a system 200 for digital content access based on a wirelessly-integrated garment is depicted, according to an embodiment. System 200 generally comprises a garment 202 having an integrated RFID component, a computing device 204 such as a mobile device, and cloud-based services 206. Certain components of system 200 are substantially similar to corresponding components of system 100. For example, garment 202 is substantially similar to one or more of garments 102. Computing device 204 is substantially similar to device 106. Cloud services 206 is substantially similar to network 108. Additional features are described herein. Computing device 204 and cloud services 206 can respectively include at least one processor and memory, the memory including a set of instructions to implement the functionality described here (e.g. when executing on the processor).

In operation, at 210, a user utilizes NFC technology of computing device 204 to send a radio frequency (RF) signal to garment 202. The RF signal can be configured to energize a passive RFID tag coupled to garment 202. For example, computing device 204 can utilize a communication at 134.2 KHz. In another embodiment, the RFID tag is active, not passive, such that the RFID tag is already energized. Accordingly, at 210, the RF signal can be configured to initiate communication with the RFID tag. In an initial communication or subsequent serial communication at 210, computing device 204 sends a request for data transfer to garment 202.

At 212, the passive coil of the RFID tag coupled to garment 202 is energized, allowing for enough energy to transmit the secure data contents of the memory of the RFID tag. The data stored in the RFID tag includes a unique identifier corresponding to the particular garment, and instructions to authenticate and access digital media from cloud services 206, which is received by computing device 204.

In an embodiment, the instructions to authenticate and access digital media comprises a hyperlink or URL accessible by a browser or other Internet navigation software. In an embodiment, the instructions to authenticate and access digital media comprises TCP port forwarding configuration or command-line instructions to automatically connect computing device 204 to the instructed IP address.

In an embodiment, at 212 the instructions to authenticate and/or access digital media can be retrieved from an external data source, such as a server or database, for example in real-time. Such an embodiment can require a network connection and/or communication protocol support for the RFID tag and reader. For example, in an embodiment, custom communication protocols between RFID tags and readers are implemented to facilitate instruction execution. Custom communication protocols can include defining message formats, command sets, and/or error handling mechanisms.

In an embodiment, embedded logic or microcontrollers on the RFID tag can process instructions internally. Processing by the RFID tag can offload some processing tasks from the RFID reader and enable more sophisticated functionality.

In an embodiment, instructions are stored in structured data formats (e.g., XML or JSON) on the RFID tag. Structured data allows for more complex instructions to be stored, including parameters and metadata. Further, unique identifiers can be incorporated with parameters or commands. For example, unique identifiers or codes can be assigned to different instructions or commands. RFID readers can then interpret these identifiers and trigger corresponding actions based on predefined mappings.

In an embodiment, a program and/or a script that is configured to be executed by an RFID reader can be locally stored on the RFID tag. Dynamic programming can allow for more flexible and scalable behavior, as instructions can be updated or modified on the fly. For example, in embodiments incorporating unique identifier mappings, the mappings can be updated using dynamic programming.

In an embodiment, the unique identifier is a hardware-based identifier. For example, every unique RFID tag can have its own unique hardware identifier as the unique identifier. In an embodiment, the unique identifier is associated with the garment. For example, a unique garment identifier particular associated with the garment (e.g. shirt design name, version, 1 of 50) as the unique identifier. In an embodiment, the unique identifier can be a hash of the RFID hardware identifier and the garment identifier.

At 214, computing device 204 utilizes the instructions communicated from the RFID tag to communicate with cloud services 206. For example, the unique identifier and instructions are used by computing device 204 to establish authentication of product (e.g. garment 202) and provide access of digital content using digital services 206. For example, the unique identifier can be used to register the product. In the embodiment of the instructions as a hyperlink, computing device 204 can navigate to a network resource of cloud services 206 as indicated by the hyperlink. At 214, computing device 204 can send the unique identifier via the hyperlink to cloud services 206. In an embodiment, cloud services 206 can include blockchain services. Blockchain services can include, for example, the proof-of-work or proof-of-stake interactions described herein.

At 216, cloud services 206 validates garment 202. For example, if the unique identifier is authenticated (e.g., as a registered product) and/or verified, access to streaming content is permitted.

At 218, the user of computing device 204 user requests access to digital content from cloud services 206 (e.g. blockchain services).

At 220, digital content is provided to computing device 204. For example, digital content can be streamed to computing device 204 from cloud services 206. Accordingly, digital content is accessible only through the data and hyperlink obtained through RFID communication with garment 202 and the RFID tag of garment 202. In another example, digital content can be downloaded to computing device 204 for later playback.

In some embodiments, digital content can be restricted to a format playable by a media player that comprises digital rights management code. In an implementation of the embodiment, a blockchain transaction can interact with a smart contract, and can return a time-limited or playback-limited activation code for the digital content. The activation code may comprise one or more of: a timestamp beyond which the digital content may not be accessed, a playback counter indicating a maximum number of times the digital content may be accessed, and a digital signature or nonce (number used only once, for example, a hash output) providing authorization for accessing the digital content.

At 222, once authentication of product registration is validated through cloud services 206 (e.g. a blockchain transaction), a new identifier is generated by cloud services 206 and optionally transmitted through computing device 204 to the RFID tag of garment 202 or is otherwise associated with garment 202. For example, the new unique identifier can be stored on the RFID tag and in cloud services 206. For example, the new identifier can be stored by cloud services and associated with garment 202 (e.g., a hardware identifier of the RFID tag of garment 202).

At 224, the RFID tag of garment 202 can optionally provide an acknowledgement (ACK) back to computing device 204 and/or to cloud services 206. Such acknowledgement can be for blockchain or other authentication transaction purposes. For example, typical blockchain transactions cannot be reversed once executed on the blockchain. In embodiments described herein, a blockchain transaction can be paused before the blockchain transaction is executed while the garment ID is updated. In implementation, a function can update a PAUSED variable. That function can only be called by the owner (e.g. via mobile device and the unique identifier). The EXECUTE blockchain function can only be called if the transaction is not paused. This ensures that the transaction reflected in the blockchain is also reflected in the garment to coordinate that the physical assets match that of the associated digital assets.

In an embodiment, operations 210-224 are executed once to provide the digital content. In another embodiment, operations 210-224 are executed multiple times to first grant access, then confirm access, for example, during download or streaming of the digital content, or access after initial download. For example, operations 210-224 can create multiple entries in the blockchain to confirm initial access and that the user continues to be associated with the garment. In an embodiment, multiple tags can be used in coordination to ensure that a primary tag remains associated with a garment using a secondary tag, thereby preventing theft of the RFID tags. In such embodiments, operations 210-224 can likewise be repeated. For example, a primary tag can be associated with digital content. A secondary tag can be associated with the garment. Computing device 204 can communicate with the primary tag to gain access to the digital content, and also communicate with the secondary tag to ensure that the primary tag is still associated with the intended garment. In embodiments, the unique identifier can be an XOR, concatenation, hashing, or other combining or aggregating of the primary tag and the secondary tag. In other embodiments, two unique identifiers are checked (e.g. a first identifier of primary tag and a second identifier of secondary tag). In an example, only one tag is read at a time. In further examples, sequential reads of one tag at a time can be conducted.

In one aspect, the primary tag cannot be programmed without the secondary tag. In one aspect, computing device 204 is not provided access to the content of the primary tag without a confirmation derived from the secondary tag (e.g. to ensure that the primary tag is still in the intended garment and was not removed). In one aspect, the primary tag provides the content and the secondary tag provides an access mechanism or security mechanism to the primary tag, such as a value provided on or derived from the secondary tag.

In an embodiment, system 200 can be used to update a non-fungible token (NFT) exchange platform (e.g., cloud service 206) that allows for the sale/transfer of ownership of digital assets associated with garments (e.g., garment 202). The NFT exchange platform can be used to provide digital content associated with physical memorabilia by creating and maintaining an association between physical memorabilia and digital assets. In an embodiment, the NFT exchange platform comprises a blockchain.

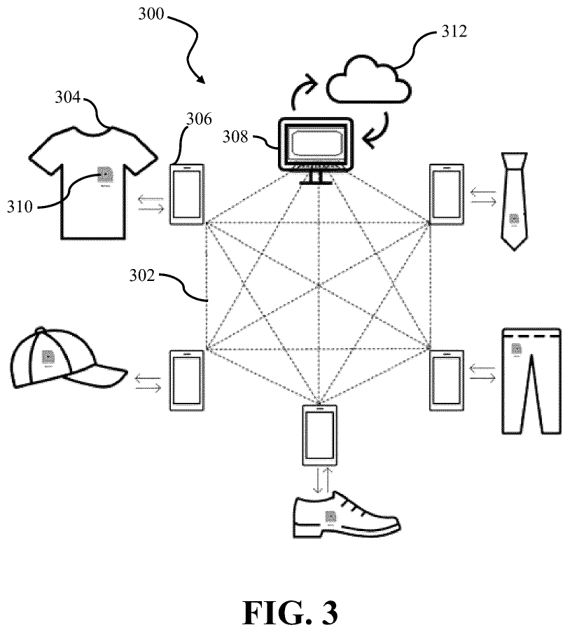

FIG. 3 is a block diagram of system 300 for accessing digital content access through blockchain 302 based on possession of a wirelessly-integrated garment 304, according to an embodiment. System 300 generally comprises a blockchain 302 accessible by computing devices 306 and a host computing device 308, such as a server.

In operation, a user can energize a contactless technology tag 310 integrated into garment 304 using computing device 306. In an embodiment, contactless technology tag 310 is one of an RFID tag or an NFC tag. Contactless technology tag 310 can, for example once energized, send instructions to computing device 306 to access cloud services 312 via blockchain 302 and host computing device 308.

In an embodiment, cloud services 312 is configured to validate garment 304 and, based on the validation, provide computing device 306 with a digital asset associated with garment 304.

In an embodiment, an NFT exchange platform can perform one or more of the following:

The NFT exchange platform can tokenize physical memorabilia, such as wirelessly-integrated garments. An NFT corresponding to a garment can be created on the blockchain. A (e.g., each) NFT can represent a unique item of physical memorabilia, such as a garment or a collectible, such as a vinyl record.

The NFT exchange platform can allow an owner of the physical memorabilia to link digital content to the corresponding NFT. In examples, an artist can link their digital content, such as images, videos, audio clips, or any other digital asset to a garment. Linking digital content to a tokenized garment can enhance the value or story of the garment.

The NFT serves as a digital certificate of ownership for the garment. When a user purchases the wirelessly-integrated garment, the user gains the associated digital content on the NFT exchange platform. By providing access to digital content, the NFT exchange platform enhances the collectible experience for owners of physical memorabilia. Owner users can explore additional information, behind-the-scenes footage, historical context, or interactive experiences related to their collectibles.

In an embodiment, the NFT exchange platform used in conjunction with wirelessly-integrated garments allows transfer of access to the associated digital content by transferring the garment itself. Use of the physical garment as a means of access simplifies secure transfer of digital content (e.g., as conventional means of authentication, such as passcodes, do not need to be exchanged between users). Accordingly, the NFT exchange platform can facilitate the re-sale of digital assets associated with wirelessly-integrated garments.

### EXAMPLE IMPLEMENTATION

In one example, an embodiment utilizes RFID/NFC tags containing unique identifiers (UIDs) that can be retrieved from a garment by scanning with a mobile phone NFC reader, and that contain rewritable memory that can be read from and written to by the mobile phone.

For example, a user scans the garment with his phone, and an application on the user's phone retrieves the UID and the current contents of the memory from the tag. The application then applies a cryptographic function to the UID and the memory contents to obtain a one-time key. The key is passed to the server by the mobile phone, together with credentials provided in the application. The credentials allow the server to determine which account to search through to extract the UID from the one-time key, providing identification for the garment and identifying which digital media assets are to be streamed back to the phone. The server also returns a new set of memory contents for the phone to write back to the garment to create a new future one-time key.

An NFC tag that contains UID functionality and read/write memory can be used, preferably one following the ISO/IEC 14443-A standard, and with encrypted communication to prevent wire-tapping and man-in-the-middle attacks.

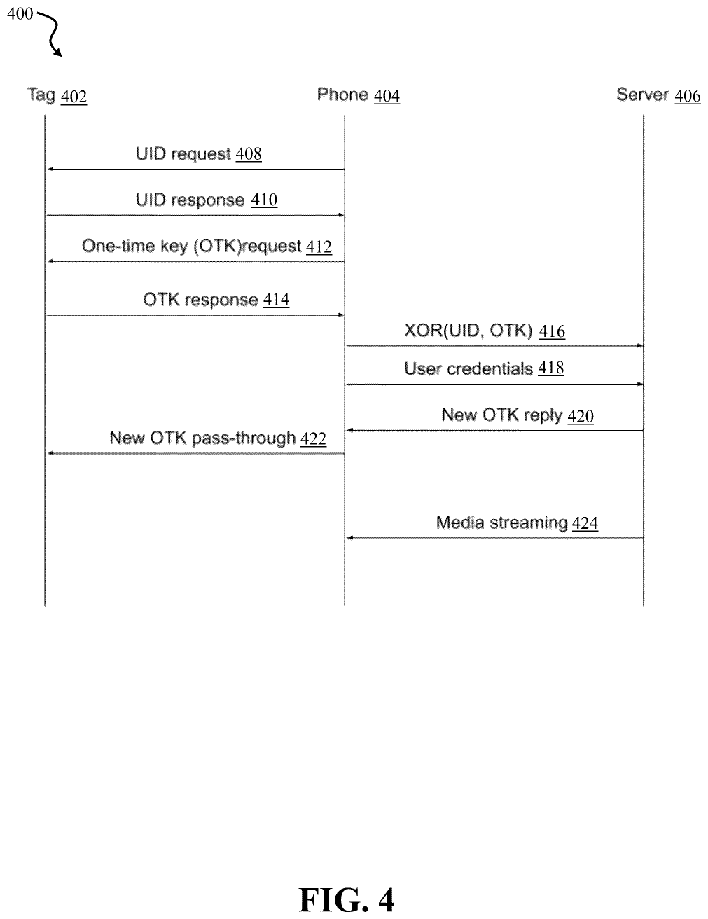

Referring further to FIG. 4, a combined block diagram and flowchart of a system 400 for digital content access based on a wirelessly-integrated item is depicted, according to an embodiment. System 400 depicts a signaling diagram illustrating an authentication method between a tag 402, a phone 404, and a server 406

A mobile phone 404 (e.g. reader) application is configured to run on ANDROID and iOS phones with NFC functionality and Internet connectivity. Optionally, digital media can be downloaded in an encrypted format that can subsequently be used offline when scanning the garment.

Tag(s) 402 contain a UID that can be read, and memory locations contain bytes split into multiple data blocks. In one aspect, the first four pages (16 bytes) are used as an identifier to confirm the tag is a relevant tag, the next page (4 bytes) indicates whether a first or a second key is active, and the final two sets of eight pages (32 bytes times two) are used to store the one-time key.

The reader retrieves the UID via request 408 and response from tag 410 and the one-time key 412, and combines them with a reversible function, for example, by applying an XOR function to combine the UID and the one-time key, to produce a key code 416.

The reader then passes the key code 416, and optionally the user's credentials 418 to media server 406. Media server 406 has a collection of records for the user as identified by the credentials, with each record storing the current one-time keys and UIDs of previously registered products. Media server 406 can loop through the stored one-time key codes for the user and XOR the stored one-time key codes for the user with the received key code in turn to see if this returns a known UID. If it does, that identifies which digital media asset should be streamed back to the user's phone 404 (424), together with a new one-time key at 420 that the reader uses to replace the data in the 32-byte data block at 422.

In one aspect, for additional security, the media streaming is over SSL. In one aspect, for further security, the media streamed can be encrypted with a stream cipher using the new one-time key.

The present method is suitable for simple RFID tags such as the MIFARE Ultralight or the NTAG213/215, which has enough memory without cryptographic security and is so inexpensive that it is used for disposable tickets.

Accordingly, an embodiment includes a secure music server running on a cloud computer or on-prem server, the server stores the music files (and potentially video files, pdf files, images, or any other kind of media file that might be of interest to music fans) and only serves them to a music player on correct authentication using the tag. In one aspect, after successful authentication, the files are downloaded. In another aspect, after successful authentication, the files are streamed.

An embodiment further includes an administrator app running on a mobile device (e.g. Android, iPhones) allows the merchandise producer to program tags and record their existence on the music server, upload media files and metadata to the server, and manage the media files, metadata, and band profile data.

An embodiment further includes a music fan app running on a mobile device that allows users to scan tags in merchandise, retrieve the media files and metadata, and play the media files a limited number of times before the merchandise must be rescanned for further plays.

### Mobile Phone Apps

Expo and React Native are an application framework that allows the writing and deployment of Android and iOS applications using React, which provides support for the functionality required on mobile devices.

In one aspect, an administrator app is provided to users wishing to use the product and embed tags in their merchandise. The administrator app allows users to set up a management account on the server, program tags, and register the existence of the tags on the server.

The administrator app can be used in a “batch mode” that can program tags at the rate of about one per second. For large batches, tags can be pre-programmed and registered during the merchandise manufacturing process.

The administrator app can allow for customization of tags; for example, at a gig as the merchandise is sold, the administrator app can be used to scan the tags at sale and write “location sold” metadata to the server. This allows fans to have their merch recorded at each gig attended, awarding them badges for being loyal fans, and other different programming based on their frequency of tag interaction.

In one aspect, a music fan app includes a scanner and a music/media player. By scanning the tag in the merchandise with the phone, the app obtains the information it needs to download or stream the media. The music fan app also acts as a library to indicate which tags have been scanned and their current status.

In one aspect, one scan provides a user a given number of plays, e.g. 5, or 20, or a time period, e.g. for the next three days, and that after the number of plays is exhausted or the time period has passed, the tag needs to be scanned again. Such options can be individually configurable by the administrator app.

In one aspect, the can tag unlocking a collection of media files, for example, an entire album of MP3s, videos, and poster images. Further files can be added to the collection after the merchandise is sold, for example, a live audio or video of the gig at which a t-shirt or cap was bought. In another example, live concert audio/video can be assigned to pre-purchased merchandise so fans who attend and make a purchase own the exact audio/video of the concert they attended. Media files can also be removed by scanning.

### Server

NextJS is a React web server framework that provides the backend for the system. Embodiments include two components, first, an API that only serves up media files and metadata if the request contains a valid tag key, and second, a media management component that allows administrators to upload, categorize, and configure the media files of the band or artist they are representing. The media management component can be accessible from a desktop or laptop web browser, or by the administrator app.

### NFC Tag

In an embodiment NTAG215 tags are utilized for embedding in a physical item. In embodiments, a ISO/IEC 14443-A standard-compliant NFC tag with rewritable memory can be used. Example page and corresponding data for tag is provided in TABLE 1 below.

TABLE 1

| Page | Sample Data | Notes |
|---|---|---|
| 0 | 04 95 dc c5 | First 3 bytes are part of the version number, |
| | | final byte is a checksum |
| 1 | 21 6f 61 80 | Remainder of tag version number, e.g. |
| | | 0495dcc5216f6180 |
| 2 | af 48 00 00 | Lock bytes |
| 3 | e1 10 3e 00 | Capacity container |
| 4 | 03 00 fe 00 | First page, often not writable |
| 5 | 50 72 6f 64 | Prod |
| 6 | 75 63 74 69 | ucti |
| 7 | 6f 6e 50 61 | onPa |
| 8 | 6c 76 00 MM | 1vMM - MM is a version number counter (for |
| | | future protocols) |
| 9 | 00 00 00 0K | K is active key (0 or 1) |
| 10 | YY YY YY YY | |
| 11 | YY YY YY YY | |
| 12 | YY YY YY YY | |
| 13 | YY YY YY YY | |
| 14 | YY YY YY YY | |
| 15 | YY YY YY YY | |
| 16 | YY YY YY YY | |
| 17 | YY YY YY YY | YYYY . . . YYYY is the first key |
| 18 | ZZ ZZ ZZ ZZ | |
| 19 | ZZ ZZ ZZ ZZ | |
| 20 | ZZ ZZ ZZ ZZ | |
| 21 | ZZ ZZ ZZ ZZ | |
| 22 | ZZ ZZ ZZ ZZ | |
| 23 | ZZ ZZ ZZ ZZ | |
| 24 | ZZ ZZ ZZ ZZ | |
| 25 | ZZ ZZ ZZ ZZ | ZZZZ . . . ZZZZ is the second key |

In solving a reliability problem, namely that if the phone is moved away from the tag before writing is complete, the key can get corrupted, embodiments can include two keys stored on the tag at the same time, with page 9 indicating which key is active. When a new key is written, only after it has successfully been written to the tag is the active key K value changed. This gives the tag a backup in that it has the current key and the previous key.

In one aspect, each file uploaded to the server is given a unique identifier indicating the customer identity and the individual asset. This is called the asset number. Metadata concerning the asset is stored in a database, where further information (e.g. song title, artist name, release date, description, associated artwork—also given an asset number). Various file metadata formats can be used for this, e.g. EXIF (exchangeable image file format) for images, ID3 for MP3 files, and so on. In aspects, suggested data ca be extracted from those metadata formats. In further aspects, a a table for each media format is provided that cross-indexes to asset numbers and customer identity numbers. In one example, metadata includes artwork, track name, artist name, release year, and duration of the song.

### FURTHER EXAMPLES

Embodiments can be further understood in view of the following examples.
Example 1. A garment integrated with an NFC/HF RFID tag, more specifically; a garment used to package the sale of digital audio content such as music, audiobooks, and sound recordings by integrating NFC/HF RFID Tag technology.
Example 2. A system comprising: a garment integrated with an NFC or HF RFID tag, more specifically; said garment with integrated tag is used to package the sale of digital audio content such as music, audiobooks, and sound recordings by utilizing Near Field Communication (NFC) or High Frequency Radio Frequency Identification (HF RFID) Tag technology, by which an NFC capable device such as a smartphone can operatively parse the NFC or HF RFID Tag data stored in memory; this is achieved through enabling the device's NFC circuitry to send an oscillating signal from its internal NFC coil; as a result electricity flows through the circuitry of the chip, generating a magnetic field; further this magnetic field generated by an NFC capable device induces a magnetic field in the tag's internal loop-inductor-antenna, thereby establishing a state of inductive coupling between NFC device and the tag integrated with the mentioned garment; further the magnetic field induces electricity in the tag, which creates a radio field; further the radio field generated by the tag interacts with the field generated by the NFC device hardware and mobile application software that operatively detects and decodes the radio field; further the tag information transferred may be used to authenticate digital rights and thereby grant access to specific digital audio content available through a specific website, or plurality of websites, by matching a pair of barcodes, passcodes, or passwords; further, upon successfully establishing digital rights to specific digital audio content, said content may be streamed from mentioned website(s).
Example 3. Further to example 2, wherein the NFC/HF RFID tag is used to authenticate digital rights and access to digital content by connecting to a special website, micro-site, virtual private network (VPN), or server that utilizes blockchain technologies to create an auditable trail.
Example 4. Further to example 2, the NFC/HF RFID tag can utilize energy harvesting methods to store energy in an internal battery connected to a semi-passive or active NFC/HF RFID Tag.
Example 5. Further to example 2, the NFC or HF RFID tag and the device can wirelessly communicate include wireless communication methods such as full duplex communication; WiFi, IR wireless communication, satellite communication, broadcast radio, microwave radio, Bluetooth, Zigbee, Wifi-Mesh, UWB, or any other method of wireless communication.
Example 6. The garment referred in examples 1 or 2 can include concert shirts, t-shirts, sweatshirts, hoodies, jackets, hats, shoes, lapel pins, decorative pins, or any other suitable garment, decorative keychains, key fobs, clothing patches, stickers, labels, sunglasses, placards, posters, index cards, rings, pendant necklaces, bracelets, charms, item, or object used to promote the sale of music or sound recordings.
Example 7. A garment integrated with an NFC or HF RFID tag, more specifically; said garment with integrated tag is used to package the sale of digital audio-visual content such as videos, movies, and images by utilizing Near Field Communication (NFC) or High Frequency Radio Frequency Identification (HF RFID) Tag technology; where said HF RFID Tag data is used to authenticate digital rights and thereby grant access to specific digital audio-visual content available through a specific website, or plurality of websites by matching a pair of barcodes, passcodes, or passwords; further, upon successfully authenticating digital rights to specific digital audio-visual content, said content may be streamed from mentioned website(s).
Example 8. The garment items of example 7 can include TV/film promotional shirts, t-shirts, sweatshirts, hoodies, jackets, hats, shoes, lapel pins, decorative pins, or any other suitable garment, item, or object used to promote the sale of movies, videos, or audio-visual recordings.
Example 9. The RFID tag of the garment in examples 1, 2, or 7 can be passive, semi-passive, or active.

1. A system comprising:
a garment comprising a contactless technology tag, wherein the contactless technology tag is associated with a digital asset; and
a device comprising a memory and at least one processor configured to:
send a signal configured to energize the contactless technology tag;
receive, from the contactless technology tag based on the signal, a unique identifier associated with the garment and instructions for accessing the digital asset;
authenticate, via a cloud service, the garment based on the unique identifier and the instructions;
receive, from the cloud service, an indication that the garment is authenticated; and
receive, based on the indication that the garment is authenticated, the digital asset.

2. The system of claim 1, wherein the contactless technology tag is a near field communication (NFC) tag.

3. The system of claim 1, wherein the contactless technology tag is a radio frequency identification (RFID) tag.

4. The system of claim 1, wherein the cloud service is a blockchain service, and wherein authentication of the garment based on the unique identifier and the instructions further comprise verifying the unique identifier is associated with a transaction of the blockchain service.

5. The system of claim 1, wherein authentication of the garment based on the unique identifier and the instructions further comprise comparing the unique identifier with a predefined identifier associated with garment.

6. The system of claim 1, wherein the digital asset is an audio recording.

7. The system of claim 1, wherein the garment further comprises a sensor, and wherein the processor is further configured to:
receive, from the sensor, environmental state data associated with the garment, wherein receipt of the digital asset is further based on the environmental state data.

8. The system of claim 1, wherein the frequency of the signal is one of 13.56 MHz, 125 KHz to 135 KHz, or 860 MHz to 960 MHz.

9. A method comprising;
sending a signal configured to energize a contactless technology tag integrated into a garment, wherein the contactless technology tag is associated with a digital asset;
receiving, from the contactless technology tag based on the signal, a unique identifier associated with the garment and instructions for accessing the digital asset;
authenticating, via a cloud service, the garment based on the unique identifier and the instructions; and
receiving, based on a determination that the garment is authenticated, the digital asset.

10. The method of claim 9, wherein the contactless technology tag is a near field communication (NFC) tag.

11. The method of claim 9, wherein the contactless technology tag is a radio frequency identification (RFID) tag.

12. The method of claim 9, wherein the cloud service is a blockchain service, and wherein authenticating the garment based on the unique identifier and the instructions comprises verifying the unique identifier is associated with a transaction of the blockchain service.

13. The method of claim 9, wherein authentication of the garment based on the unique identifier and the instructions comprises a comparison of the unique identifier with a predefined identifier associated with garment.

14. The method of claim 9, wherein the digital asset is an audio recording.

15. The method of claim 9, wherein the garment further comprises a sensor, and wherein the method further comprises:
receiving, from the sensor, environmental state data associated with the garment, wherein receipt of the digital asset is further based on the environmental state data.

16. The method of claim 9, wherein the frequency of the signal is one of 13.56 MHZ, 125 KHz to 135 KHz, or 860 MHz to 960 MHz.

17. A system comprising:
a garment comprising a first contactless technology tag and a second contactless technology tag, wherein the first contactless technology tag is associated with a digital asset and the second contactless technology tag is associated with the garment; and
a device comprising a memory and at least one processor configured to:
send a signal configured to energize the first contactless technology tag and the second contactless technology tag;
receive, from the first contactless technology tag based on the signal, instructions for accessing the digital asset;
receive, from the second contactless technology tag based on the signal, a unique identifier associated with the garment;
authenticate, via a cloud service, the garment based on the unique identifier and the instructions;
receive, from the cloud service, an indication that the garment is authenticated; and
receive, based on the indication that the garment is authenticated, the digital asset.

18. The system of claim 17, wherein the first contactless technology tag is a first near field communication (NFC) tag and the second contactless technology tag is a second NFC tag.

19. The system of claim 17, wherein the first contactless technology tag is a first radio frequency identification (RFID) tag, and wherein the second contactless technology tag is a second RFID tag.

20. The system of claim 17, wherein the cloud service is a blockchain service, and wherein authentication of the garment based on the unique identifier and the instructions comprises verifying the unique identifier is associated with a transaction of the blockchain service and verifying the unique identifier is associated with the digital asset.
